(19) United States
(12) Patent Application Publication
(10) Pub. No.: US 2024/0375747 A1
(43) Pub. Date: Nov. 14, 2024

(54) METHOD FOR OPERATING A BICYCLE DRIVE

(71) Applicant: ZF Friedrichshafen AG, Friedrichshafen (DE)

(72) Inventor: Johannes Proschek, Tübingen (DE)

(21) Appl. No.: 18/687,873

(22) PCT Filed: Aug. 30, 2022
(86) PCT No.: PCT/EP2022/074022

§ 371 Date: Feb. 29, 2024

(30) Foreign Application Priority Data
Aug. 30, 2021 (DE) 10 2021 209 469.4

(51) Int. Cl. B62M 6/45; B62M 11/06

(52) U.S. Cl. CPC B62M 6/45; B62M 11/06

(57) ABSTRACT

A method for operating a bicycle drive (10) with a crank axle (12), an electric drive motor (38), and a gearing (18) is provided. The gearing (18) includes a shift element (26) for changing a gear stage and first and second gearing elements (20, 24). The gearing (18) is configured to shiftably transmit a torque from the crank axle (12) to an output (22) of the bicycle drive (10) with at least one first gear stage and one second gear stage. The first gearing element (20) is connected to the second gearing element (24) by the shift element (26) for torque transmission in one of the two gear stages. The method includes detecting a request for a gear step change and controlling the drive motor (38) depending on the detected request for gear step change in order to reduce a load which is applied at the shift element (26).

### CROSS-REFERENCE TO RELATED APPLICATIONS

The present application is a U.S. national phase of PCT/EP2022/074022 filed on Aug. 30, 2022 and is related and has right of priority to German Patent Application No. DE102021209469.4 filed on Aug. 30, 2021, both of which are incorporated by reference in their entireties for all purposes.

### TECHNICAL FIELD

The present invention relates to generally to a method for operating a bicycle drive, to a bicycle drive, and a bicycle.

### BACKGROUND

Bicycles are increasingly utilized as a primary means of personal transportation. Accordingly, there are high requirements on the ride comfort and performance of bicycles. For example, bicycles are used not only for riding, but also for transporting purchased items and children. Bicycles are also utilized as sports equipment. In order to increase comfort and performance, many bicycles are equipped with an electric drive motor, which assists the rider in the propulsion of the bicycle. Such bicycles are referred to as pedelecs.

For the most efficient riding possible, bicycles are usually equipped with a gearing, which is designed to provide different transmission ratios for a torque transmission of a pedal crank of the bicycle and, alternatively or additionally, of an electric drive motor. It is desirable that a gear ratio change be carried out as reliably and quickly as possible. If the gearing does not shift or surprisingly shifts with delay when a gear ratio change is demanded, undesirable riding states can arise, which hinder the rider. At the beginning of an uphill grade, for example, the rider can request a gear which is lower than the current gear as soon as pedaling resistance at the pedal crank becomes too great. If the gear ratio change is then not carried out in a timely manner, for example, it can become impossible for the rider to apply sufficient muscle power at the pedal crank to continue moving. An undesirable stop can therefore result.

Similarly, numerous gear changes and a demanding utilization of a bicycle can prematurely result in excessive wear, for example, even if the rider is assisted by a drive motor while riding.

### SUMMARY

A first example aspect of the invention relates to a method for operating a bicycle drive. The method can relate, for example, only to a behavior of the bicycle drive during a gear change operation. The bicycle drive can be designed to propel the bicycle by muscle power and, alternatively or additionally, by an electrically generated drive force. By the bicycle drive, for example, a rear wheel of the bicycle can be set into rotation. The bicycle drive can be designed, for example, as a drive for a pedelec.

The bicycle drive has a crank axle. The crank axle can extend through a frame of the bicycle in the left-right direction. The crank axle can be designed to have a pedal crank mounted at each end. A pedal can be attached to each pedal crank. The crank axle can form an input shaft of the bicycle drive. Muscle power for propelling the bicycle, for example, can be introduced into the bicycle drive at the crank axle.

The bicycle drive has an electric drive motor. The electric drive motor can be designed to convert electrical energy into rotational energy. The drive motor can include an output shaft at which the drive motor can provide a torque. The drive motor can be arranged in the frame of the bicycle, for example, adjacently to the pedal crank. The drive motor can be mechanically operatively connected or operatively connectable, for example, to the crank axle of the bicycle drive or to an output of the bicycle drive. A mechanical operative connection can be formed, for example, via a spur gear stage, a chain or a belt, in order to transmit torque. “Operatively connectable” can mean that the mechanical operative connection is disconnectable, for example, by an engageable and disengageable element such as a friction clutch. “Operatively connected” can mean that disconnection is not possible. The bicycle drive can be designed such that a drive force is provided by the drive motor only if the rider provides the bicycle drive with a predetermined minimum force for riding with muscle power.

The bicycle drive has a gearing. The crank axle can be a shaft of the gearing, for example, an input shaft. The crank axle can also not be part of the gearing, for example, and can be mechanically operatively connected or operatively connectable to an input shaft of the gearing. For example, the crank axle can be permanently connected to the input shaft of the gearing for conjoint rotation. An output shaft of the gearing can form an output of the bicycle drive or can be mechanically operatively connected or operatively connectable to the output of the bicycle drive. The output of the bicycle drive can, for example, provide drive power for the bicycle.

The gearing has a shift element for changing a gear stage. A gear stage can correspond to a gear of the gearing and thus of the bicycle. In a gear of the gearing, there can be a fixed transmission ratio between a rotational speed and a torque at the crank axle and the output. Each gear can provide a different transmission ratio. Each gear stage can correspond to a range of ratios, however, wherein a current transmission ratio can be further adapted depending on other factors.

A shift between at least two gear stages can be carried out by actuating the shift element. The gearing is designed to shiftably transmit a torque from the crank axle to an output of the bicycle drive with at least one first gear stage and one second gear stage. The shift element can be designed, for example, as a friction clutch or a shift pawl. The gearing has a first gearing element and a second gearing element. The first gearing element is connected to the second gearing element by the shift element for torque transmission in one of the two gear stages. For example, the shift element can connect the two gearing elements to each other for conjoint rotation. The first gearing element can be separated from the second gearing element in another of the two gear stages, for example, by disengaging the shift element and thus interrupting the torque transmission. For example, the gearing can nevertheless continue to transmit a torque from the crank axle to the output, although, for example, via other gearing elements and, alternatively or additionally, with another transmission ratio. In the other of the two gear stages, the first gearing element and, alternatively or additionally, the second gearing element can also be connected to another gearing element by the shift element for torque transmission.

A gearing element can be, for example, a rotary element of the gearing. A gearing element can be designed, for example, as a toothed wheel, a shaft or a rotary element of a planetary gear set, such as a sun gear, a planet carrier or a ring gear. A gearing element can also be designed, for example, as a stationary component, such as a bicycle frame or a gearing housing.

The shift element can be actively actuated, for example, via a gear change device, for example, by a cable pull of a manual gearbox. The shift element can also be designed to automatically shift in certain states of the gearing and thus change state. The shift element can also be actuated by a servomotor, which is controlled via an electrical signal. For example, a rider can actuate a button or a lever in order to bring about a motor-operated or manual actuation of the shift element.

If a shift element, for example, a clutch, is provided between two gearing elements, these gearing elements are not permanently connected to each other for conjoint rotation, but rather are connectable to each other for conjoint rotation via the shift element. A corotational connection is established only via actuation or an automatic state change of the intermediate shift element. An actuation of the shift element can mean that the shift element is transferred into an engaged state such that the gearing elements which are directly coupled to the shift element can be synchronized in terms of rotational motions. If the shift element concerned is in the form of an interlocking shift element, the components which are directly connected to each other for conjoint rotation via the shift element rotate at the same rotational speed. One example of an interlocking shift element is a dog clutch. In the case of a friction-locking shift element, rotational speed differences between the gearing elements can exist even after the shift element has been actuated. This intentional or also unintentional state is nevertheless referred to here as a corotational connection of the respective components. In the case of a frictional connection, there can be a certain speed differential between the two interconnected gearing elements, for example, due to slip.

The gearing can also be designed to provide further gear stages. Therefore, further gearing elements and, alternatively or additionally, shift elements can also be provided. The method can be similarly applied in this case.

The method includes detecting a request for a gear step change. The request for a gear step change can be, for example, an actuation of the shift element or an electrical signal, for example, when a gearing can be actuated by a motor. The detection can take place, for example, by sensors or only by receiving a signal.

The method includes controlling the drive motor depending on the detected request for a gear step change in order to reduce a load which is applied at the shift element. The applied load can be reduced, for example, by modifying or providing a motor torque, which is applied by the drive motor onto one of the two gearing elements.

For example, the drive motor can be controlled such that a motor torque provided by the drive motor is reduced as compared to a motor torque provided prior to the detection of the request for a gear step change and, alternatively or additionally, a lower overall torque acts on one gearing element or on both of the two gearing elements. For example, assistance to the rider in propelling the bicycle can be temporarily reduced. For example, vice versa, the drive motor can also be controlled such that a motor torque provided by the drive motor is increased as compared to a motor torque provided prior to the detection of the request for a gear step change. If the overall drive force of the bicycle was provided only via muscle power prior to the detection of the request for a gear step change, i.e., the drive motor did not provide assistance to propel the bicycle, then, in response to the detected request for a gear step change, a drive force can also be temporarily provided with the drive motor or the muscle power can be temporarily counteracted. The control of the drive motor depending on the detected request for a gear step change in order to reduce a load which is applied at the shift element can be superimposed with a control for providing a drive force by means of the drive motor.

The drive motor can be controlled, for example, such that the load on the shift element is reduced to zero or nearly to zero, as a result of which a load-free gear shift is made possible. The drive motor can be controlled depending on the detected request for a gear step change in order to reduce a load which is applied at the shift element, for example, only until the gear stage has been successfully changed in response to the request for a gear step change. The control of the drive motor depending on the detected request for a gear step change in order to reduce a load which is applied at the shift element can cause a shift-element-unloading torque to be generated.

The two aforementioned steps are based, among other things, on the finding that every actuation of the shift element does not always also similarly result in a change in the state of the shift element in the case of a bicycle. For example, a shift element in the form of a locking pawl cannot disengage from one of the two gearing elements or engage with the gearing element in certain states, despite the shift element having been actuated. For example, a rider can continue to apply force to respective pedals of a pedal crank during a desired gear change operation. As a result, a load can act on the shift element, which load prevents the locking pawl from being pulled out of engagement. Respective reaction forces then hold the locking pawl. Despite the state no longer being an engaged state, the locking pawl does not pop out. Such states frequently arise during shifting on an uphill grade, for example, among inexperienced riders. Such a state can be prevented or eliminated by appropriately actuating the drive motor to reduce the load on the shift element.

The two aforementioned steps are also based, among other things, on the finding that an unnecessarily high load acts on the shift element in certain riding states, which load can increase the wear. For example, high levels of friction can arise if a locking pawl is engaged or disengaged under a high load. Similarly, a high level of friction work can arise on a friction-locking clutch if a high load is already acting on a clutch half even prior to a complete engagement or disengagement. This can be prevented or at least reduced by appropriately actuating the drive motor to reduce the load on the shift element.

The method can also include interrupting the torque transmission between the first gearing element and the second gearing element by the shift element, for example, by disengaging the shift element. As a result, the gear stage can be changed. The torque transmission can be interrupted due to the unloading via appropriate control of the drive motor once the gear step change has been requested.

In one example embodiment of the method, it is provided that the control of the drive motor in order to reduce a load which is applied at the shift element takes place only if the detected request for a gear step change is a request to change from a higher gear stage to a lower gear stage. For example, this can be a request for a change from the second gear stage to the first gear stage. A higher gear stage can correspond to a higher gear. A lower gear stage can correspond to a lower gear. The higher gear can, for example, convert a certain rotation of the crank axle into a faster rotation of the output than the lower gear can achieve starting with the same rotation of the crank axle. It can therefore be taken into account that unloading the shift element may be necessary only for a downshift in order to successfully carry out a gear change operation. In the case of an upshift, by comparison, the changed transmission ratio can already bring about an unloading and, alternatively or additionally, the shift element is no longer prevented from disengaging due to reaction forces.

In one example embodiment of the method, it is provided that the drive motor is designed to introduce a motor torque into the bicycle drive on the drive side with respect to the shift element. For example, the drive motor can be mechanically operatively connected to the crank axle and, alternatively or additionally, to the gearing element on the crank-axle-side in the torque flow. The torque provided by the drive motor can be transmitted to the output, for example, via the gearing. Due to the control in order to reduce a load which is applied at the shift element, the drive motor can apply the motor torque as a decelerating motor torque at one of the two gearing elements. The decelerating motor torque can counteract a propulsion of the bicycle in the forward direction. For example, less torque or a torque which counteracts the propulsion of the bicycle can be applied at the gearing element on the crank-axle-side in the torque flow due to the control as compared to a previously unchanged motor control. The torque at the output shaft of the drive motor can be composed, for example, of a drive torque for assisting the rider and an unloading motor torque, wherein the drive motor is controlled to provide the appropriate torque at the output shaft of the drive motor. For example, the output shaft of the drive motor can be briefly decelerated in order to unload the shift element.

In one example embodiment of the method, it is provided that the drive motor is designed to introduce a motor torque into the bicycle drive on the output side with respect the shift element. For example, the drive motor can be mechanically operatively connected to the output, for example, by-passing the gearing and, alternatively or additionally, to the gearing element which is on the output side in the torque flow. Due to the control in order to reduce a load which is applied at the shift element, the drive motor can apply the motor torque as an accelerating motor torque at one of the two gearing elements. For example, drive power provided by the drive motor can be increased due to this control. For example, the output shaft of the drive motor can be briefly accelerated in order to unload the shift element.

In one example embodiment of the method, it is provided that the control of the drive motor depending on the detected request for a gear step change in order to reduce a load which is applied at the shift element is carried out for a predetermined time period. As a result, a permanent reduction of drive power can be prevented, even if the gear step change should fail despite the load reduction. In addition, such a control can be easily and cost-effectively implemented. For example, the time period can be constant or predetermined depending on a state of the propulsion system. For example, the time period can be determined depending on a rotational speed of one of the two gearing elements, a rotational speed of the output, a rotational speed of the output shaft of the drive motor, a rotational speed of the crank axle and, alternatively or additionally, on a current gear stage and, alternatively or additionally, on a desired gear stage. Respective values for determining the predetermined time period can be calculated from other states of the propulsion system or even detected using sensors. Similarly, a variable of a torque change at the output shaft of the drive motor for unloading the shift element can be determined depending on these values.

In one example embodiment of the method, it is provided that the method also includes detecting a gear step change. For example, it can be detected when the gear stage has been successfully changed. The detection can take place indirectly depending on a state of the propulsion system, such as depending on a rotational speed of one of the two gearing elements, a rotational speed of the output, a rotational speed of the output shaft of the drive motor, a rotational speed of the crank axle and, alternatively or additionally, a change in these values. The detection can also take place directly by a sensor. The control of the drive motor depending on the detected request for a gear step change in order to reduce a load which is applied at the shift element can be carried out until the gear step change has been detected.

As a result, the control of the drive motor depending on the detected request for a gear step change can be terminated at a particularly efficient point in time.

In one example embodiment of the method, it is provided that the method also includes controlling the drive motor in order to reduce a drag torque which has been caused by the drive motor, provided that propulsion assistance has not been requested of the drive motor. This step can avoid increased riding resistance if the drive motor is permanently mechanically operatively connected to the rest of the propulsion system in order to be able to unload the shift element during a gear stage change. The bicycle drive therefore requires only a few shift elements, as a result of which the bicycle drive can be particularly lightweight and low-cost. Nevertheless, excessively strong pedaling resistance due to a drag of the drive motor can be avoided if the aim is only to propel the bicycle using muscle power without assistance from a motor. In addition, recuperation with the drive motor is easily possible in the design having a permanently mechanically operatively connected drive motor. For example, the drive motor can be controlled such that a drag torque of the drive motor is completely compensated for and thus eliminated. In such a mode, the riding feel and the force necessary for propelling the bicycle can therefore substantially correspond to a propulsion system which is otherwise identical, although with the drive motor decoupled. This compensation of the drag torque can always takes place, for example, provided that a request for a gear step change is not present or provided that a request for a gear step change from a low gear step to a higher gear step is not present. Due to the control of the drive motor for the purpose of reducing a load which is applied at the shift element, the drive motor can apply the motor torque as a decelerating motor torque at one of the two gearing elements by no longer compensating for the drag torque or compensating for the drag torque to a lesser extent. As a result, the method can be particularly energy efficient.

In one example embodiment of the method, it is provided that the gearing has an engageable and disengageable freewheel element, wherein the drive motor is connectable to the gearing by the freewheel element for torque transmission. The freewheel element can switch automatically between an overrun operation state and a locking direction state. As a result, the drive motor can be automatically decoupled as soon as the drive motor no longer provides drive power for propelling the bicycle. As a result, drag losses due to the drive motor being carried along can be avoided, for example, if the bicycle is to be propelled using only muscle power.

The method can also include establishing torque transmission between the drive motor and the output by the freewheel element, provided that the drive motor is controlled depending on the detected request for a gear step change in order to reduce a load which is applied at the shift element. This can take place, for example, by engaging the freewheel element. The freewheel element can therefore be engaged in order to be able to unload the shift element during the gear change operation. For example, an overrun operation state can thus be interrupted in order to be able to decelerate one of the two gearing elements by the drive motor.

The method can also include interrupting torque transmission between the drive motor and the output by of the freewheel element, provided that propulsion assistance is no longer requested of the drive motor and provided that the drive motor is not controlled depending on the detected request for a gear step change in order to reduce a load which is applied at the shift element. The freewheel element can then be engaged, for example, such that the freewheel element automatically switches again between the overrun operation state and the locking direction state. A freewheel of the engageable and disengageable freewheel element can also be blocked in order to enable recuperation with the drive motor.

A second example aspect of the invention relates to a bicycle drive. The bicycle drive can be designed to be operated using the method according to the first example aspect. The features and advantages resulting from the method according to the first example aspect are to be derived from the descriptions of the first example aspect, wherein advantageous example embodiments of the first example aspect are to be considered to be advantageous example embodiments of the second example aspect, and vice versa.

The bicycle drive has at least one crank axle, an electric drive motor, a control device and a gearing, which has a shift element for changing a gear stage, a first gearing element and a second gearing element. The gearing is designed to shiftably transmit a torque from the crank axle to an output of the bicycle drive with at least one first gear stage and one second gear stage. The first gearing element is connected to the second gearing element by the shift element for torque transmission in one of the two gear stages. The bicycle drive can have an energy storage device for electrical energy, such as a battery. The energy storage device can supply the drive motor and, optionally, also the control device with electrical energy. The propulsion system has an output which can be formed, for example, by an output shaft of the gearing.

The control device is designed to detect a request for gear step change and to control the drive motor depending on the detected request for a gear step change in order to reduce a load which is applied at the shift element. The control device can be designed, for detection, to receive electrical signals, for example, from a switch or a sensor. The control device can include an inverter for controlling the drive motor. The control device can be programmable and, for example, include a microprocessor. The control device can ensure that requests for a gear step change are reliably and quickly implemented and that wear on a propulsion system is low.

The drive motor can be permanently mechanically operatively connected to the output of the propulsion system, for example, via a spur gear stage, for torque transmission. The bicycle drive can be free of a freewheel or a shift element between the drive motor and the gearing and, alternatively or additionally, the drive motor and the output. The drive motor can be mechanically operatively connected or operatively connectable, for example, to the crank axle and, alternatively or additionally, to the output. For example, the drive motor can be mechanically operatively connected to the output and, alternatively or additionally, to the gearing by an engageable and disengageable freewheel element.

In one example embodiment of the bicycle drive, it is provided that the shift element is in the form of an interlocking or friction-locking shift element. One example of an interlocking shift element is a shift pawl or a shifting dog. As a result of the unloading due to the control of the drive motor, a connection of the two gearing elements can be particularly reliably released via the shift element, even if the bicycle rider pushes the pedals of the pedal crank unabated during the gear step change. The friction-locking shift element can be in the form, for example, of a single-disk dry clutch. As a result of the unloading due to the control of the drive motor, friction work on the friction-locking shift element can be reduced, even if the bicycle rider pushes the pedals of the pedal crank unabated during the gear step change. As a result, the friction-locking shift element can be designed for low friction work, as a result of which the propulsion system can be compact, lightweight and low-cost. Alternatively or additionally, wear of the friction-locking shift element can be particularly low.

A third example aspect relates to a bicycle. The bicycle can have a bicycle drive according to the second example aspect. The features and advantages resulting from the bicycle drive according to the second example aspect are to be derived from the descriptions of the first and the second example aspects, wherein advantageous example embodiments of the first and the second example aspects are to be considered to be advantageous example embodiments of the third example aspect, and vice versa.

### BRIEF DESCRIPTION OF THE FIGURES

FIG. 1 schematically illustrates a method for operating a bicycle drive according to an example embodiment.

FIG. 2 schematically illustrates a bicycle drive, which can be operated by the method shown in FIG. 1.

FIG. 3 shows a schematic perspective view of a gearing, which can form a part of the bicycle drive shown in FIG. 2.

FIG. 4 shows a first schematic perspective view of two gearing elements and one shift element of the gearing shown in FIG. 3.

FIG. 5 shows a second schematic perspective view of the two gearing elements and the shift element of the gearing shown in FIG. 3.

FIG. 6 shows a schematic sectional side view of the shift element of the gearing shown in FIG. 3, in a disengaged state.

FIG. 7 shows a schematic sectional side view of the shift element of the gearing shown in FIG. 3, in an engaged state.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

FIG. 2 schematically illustrates a bicycle drive 10. The bicycle drive 10 has a crank axle 12, at each of the two opposite axial ends of which a pedal crank 14 having a pedal 16 is attached. A rider can introduce a drive force into the bicycle drive 10 using muscle power by pushing the pedals 16.

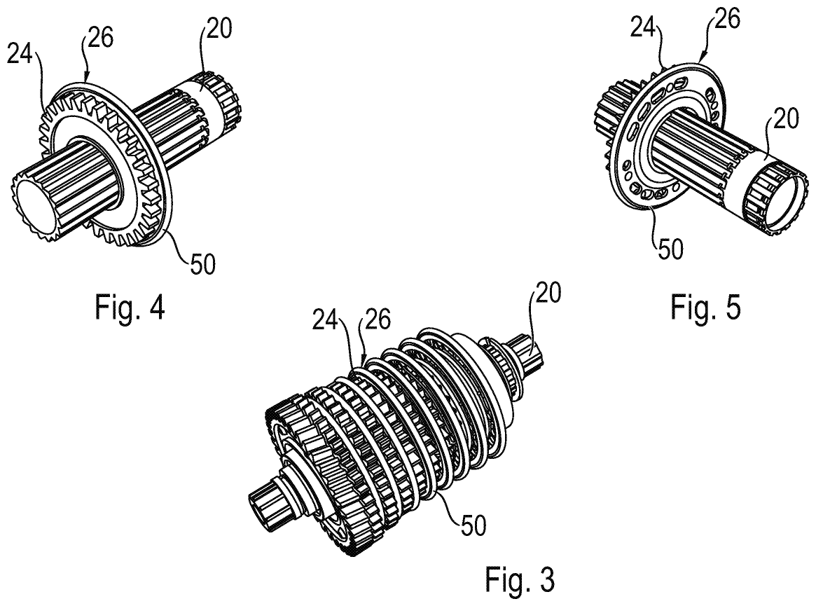

The bicycle drive 10 has a gearing 18. A very simple design of the gearing is illustrated in FIG. 2. The gearing 18 can also have a more complex design, however, as is shown in FIG. 3, wherein this more complex gearing 18 is only partially shown. The gearing 18 has at least one first gearing element 20, which is in the form of an input shaft. The first gearing element 20 is connected to the crank axle 12 permanently for conjoint rotation or via a freewheel unit (not shown). The drive torque generated by muscle power can thus be introduced into the gearing 18 via the first gearing element 20.

The gearing 18 is designed to shiftably transmit a torque from the crank axle 12 to an output 22 of the bicycle drive 10 with at least one first gear stage, which corresponds to a first gear, and one second gear stage, which corresponds to a second gear. The more complex gearing 18 shown in FIG. 3 can provide further gear stages. The output 22 of the bicycle drive 10 is formed by a pinion and is mechanically operatively connected to a hub of a rear wheel of the bicycle by a bicycle chain in the example embodiment shown.

The gearing 18 has a second gearing element 24 in the form of a toothed wheel. In addition, the gearing 18 has a shift element 26. The more complex gearing 18 shown in FIG. 3 has further shift elements for providing respective associated gear stages. The shift element 26 is designed to connect the second gearing element 24 to the first gearing element 20 for conjoint rotation. For this purpose, the shift element 26 is moved into the engaged state in order to thus engage the second gear as a gear stage. The drive torque generated by muscle power can thus be transmitted from the pedal crank 12 to the second gearing element 24 via the first gearing element 20.

The second gearing element 24 forms a spur gear stage together with a further toothed wheel 30, which is permanently connected to an intermediate shaft 28 for conjoint rotation. A further spur gear stage having further toothed wheels 32, 34 transmits the torque in the second gear to an output shaft 36. The output shaft 36 is permanently connected to the output 22 for conjoint rotation and therefore also forms the output. In the second gear, the drive torque generated by muscle power is transmitted to the output 22 via two spur gear stages of the gearing 18.

In order to engage the first gear as a gear stage in the more complex gearing 18 shown in FIG. 3, another shift element can be engaged and the shift element 26 can be disengaged. In the gearing 18 shown in FIG. 2, the shift element 26 is actuated such that the connection between the first gearing element 20 and the second gearing element 24 is released. This connection is therefore disengaged with the shift element 26. The shift element 26 is then moved such that the first gearing element 20 is connected to the output shaft 36 as the third gearing element for conjoint rotation. In the first gear, the drive torque generated by muscle power is transmitted to the output 22 without spur gear stages of the gearing 18. The transmission ratio in the first gear of the gearing 18 is lower than in the second gear.

In addition, the bicycle drive 10 has an electric drive motor 38. The drive motor 38 is permanently mechanically operatively connected to the output 22 via a further spur gear stage 40. In further example embodiments, an actively and, alternatively or additionally, automatically, engageable and disengageable connection with the output 22 is provided. The drive motor 38 can convert electrical energy into a drive force provided by a motor, which drive force is also transmitted onto the output 22 and can assist the bicycle rider in propelling the bicycle.

If the intention is, for example, to shift from the second gear into the first gear, the rider can actuate an appropriate shift lever to move the shift element 26. This yields a request for a gear step change. If a load is still applied at the shift element 26, however, for example, because the rider is still pushing hard on the pedals 16, respective reaction forces can block a release of the connection of the first gearing element 20 with the second gearing element 24 by the shift element 26. A gear ratio change therefore does not occur or does so only with delay, which can be unpleasant for the rider.

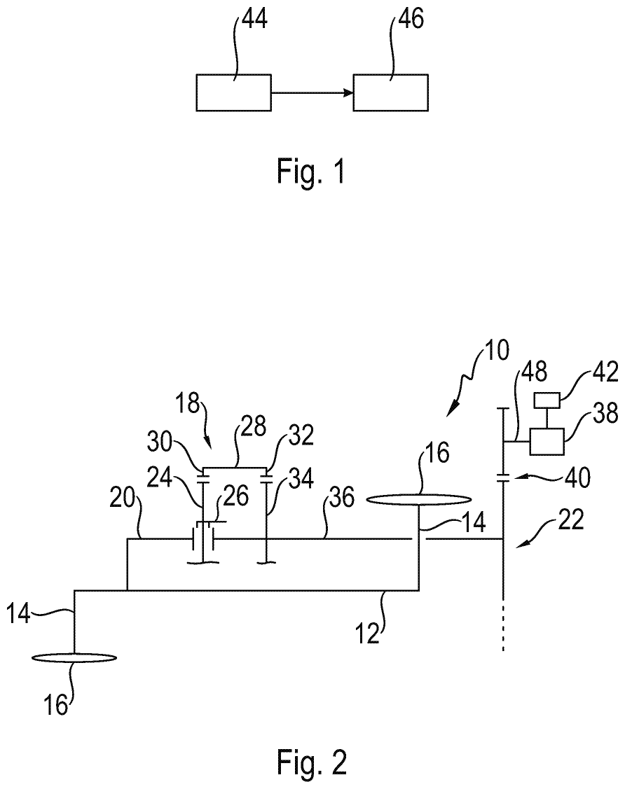

In order to prevent this, the bicycle drive 10 includes a control device 42 which controls a drive force of the drive motor 38. The bicycle drive 10 is additionally designed to be operated with a method illustrated in FIG. 1.

In a first step 44, the request for a gear step change, i.e., the actuation of the shift lever in the exemplary embodiment shown, is detected by the control device 42. In a second step 46, the control device 42 controls the drive motor 38 depending on the detected request for gear step change in order to reduce a load which is applied at the shift element 26. For example, a rotation of an output shaft 48 of the drive motor 38 is accelerated as compared to a rotation prior to the detection of the request for a gear step change. As a result, a load on the shift element 26 can be reduced by way of the second gearing element 24 then rotating approximately as fast as or even faster than the first gearing element 20 despite the fact that the rider continues to push the pedals 16. As a result, respective reaction forces on the shift element 26 are reduced and the connection of the first gearing element 20 with the second gearing element 24 can be reliably released by the shift element 26.

The control of the drive motor 38 depending on the detected request for gear step change in order to reduce a load which is applied at the shift element 26 takes place for a predetermined time period in the exemplary embodiment shown. Thereafter, the drive motor 38 is again controlled in a normal mode, which controls, for example, the motor assistance in propelling the bicycle depending on a rotational speed of the crank axle 12 and, optionally, an engaged gear and, further optionally, a gear stage. The method shown in FIG. 1 is utilized in another example embodiment only to control the drive motor if the bicycle is to be propelled purely by muscle power.

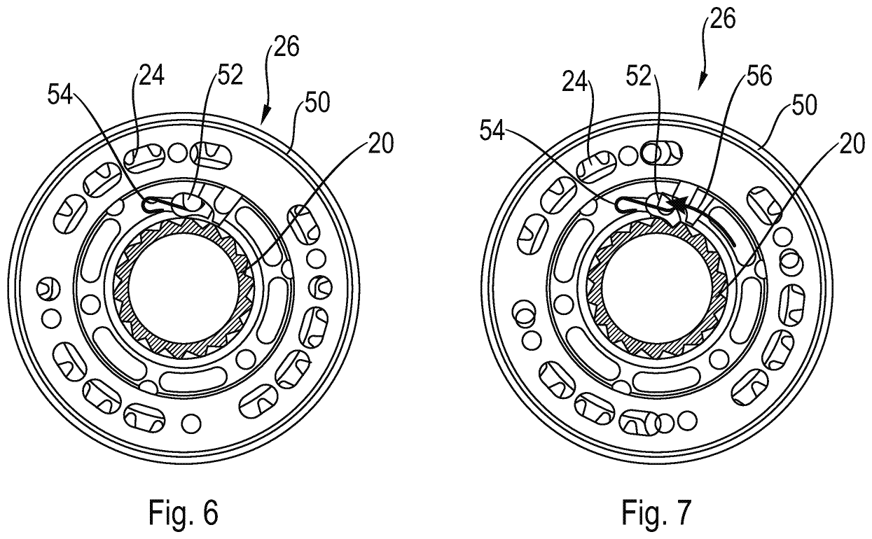

FIGS. 3, 4 and 5 show that the first gearing element 24 has external teeth on the shaft. Respective further gearing elements, including the second gearing element 26, are arranged axially next to one another coaxially with the shaft. The shift element 26 is in the form of an interlocking locking pawl, which is clearly apparent in FIG. 6 and FIG. 7.

The shift element 26 has a disk 50. When the disk 50 is actuated, a pawl 52 is engaged with the teeth on the first gearing element 24. The state with engagement and thus the connection for transmitting torque between the first gearing element 20 and the second gearing element 24 is shown in FIG. 7. The disengaged state without engagement and thus without a connection for transmitting torque between the first gearing element 20 and the second gearing element 24 is shown in FIG. 6.

A reaction force 56 is illustrated in FIG. 7, which acts on the pawl 52 and can prevent the shift into the disengaged state as described above. A spring 54 of the shift element 26 then no longer has sufficient spring force to release the pawl 52 from the engagement. According to the method shown in FIG. 1, the drive motor 38 can be controlled such that the shift element 26 is no longer under such a high load that the spring 54 cannot release the engagement.

In another example embodiment, the drive motor 38 introduces drive force into the bicycle drive 10 on the pedal-crank-side in the torque flow by way of the drive motor 38 being mechanically operatively connected to the crank axle 12 or the first gearing element 20. In order to reduce a load on the shift element 26, the second gearing element 24 is no longer accelerated with the drive motor 38, but rather the first gearing element 20 is decelerated.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

10 bicycle drive
12 crank axle
14 pedal crank
16 pedal
18 gearing
20 first gearing element
22 output
24 second gearing element
26 shift element
28 intermediate shaft
30 toothed wheel
32 toothed wheel
34 toothed wheel
36 output shaft
38 electric drive motor
40 spur gear stage
42 control device
44 first step
46 second step
48 output shaft of the drive motor
50 disk
52 pawl
54 spring
56 reaction force

1-11: (canceled)

12. A method for operating a bicycle drive (10) with a crank axle (12), an electric drive motor (38), and a gearing (18) including a shift element (26) for changing a gear stage, a first gearing element (20), and a second gearing element (24), the gearing (18) configured to shiftably transmit a torque from the crank axle (12) to an output (22) of the bicycle drive (10) with at least one first gear stage and one second gear stage, the first gearing element (20) connected to the second gearing element (24) by the shift element (26) for torque transmission in one of the two gear stages, the method comprising:
detecting a request for a gear step change; and
controlling the drive motor (38) depending on the request for the gear step change in order to reduce a load applied at the shift element (26).

13. The method of claim 12, wherein controlling the drive motor (38) comprises controlling the drive motor (38) only when the request for the gear step change is a request to change from a higher gear stage to a lower gear stage.

14. The method of claim 12, wherein:
the drive motor (38) is configured to apply a motor torque into the bicycle drive (10) on a drive side with respect the shift element (26); and
controlling the drive motor (38) comprises controlling the drive motor (38) such that the drive motor (38) applies the motor torque as a decelerating motor torque at one of the first and second gearing elements (20, 24) in order to reduce the load applied at the shift element (26).

15. The method of claim 12, wherein:
the drive motor (38) is configured to apply a motor torque into the bicycle drive (10) on an output side with respect the shift element (26); and
controlling the drive motor (38) comprises controlling the drive motor (38) such that the drive motor (38) applies the motor torque as an accelerating motor torque at one of the first and second gearing elements (20, 24) in order to reduce the load applied at the shift element (26).

16. The method of claim 12, wherein controlling the drive motor (38) comprises controlling the drive motor (38) for a predetermined time period.

17. The method of claim 12, further comprising detecting the gear step change, wherein controlling the drive motor (38) comprises controlling the drive motor (38) until the gear step change has been detected.

18. The method of claim 12, further comprising controlling the drive motor (38) in order to reduce a drag torque by the drive motor (38) when propulsion assistance has not been requested of the drive motor (38).

19. The method of claim 12, wherein:
the gearing (18) comprises an engageable and disengageable freewheel;
the drive motor (38) is connectable to the gearing (18) by the freewheel element for torque transmission; and
the method further comprises establishing torque transmission between the drive motor (38) and the output (22) via the freewheel element while the drive motor (38) is controlled to reduce the load at the shift element (26).

20. A bicycle drive (10), comprising:
a crank axle (12);
an electric drive motor (38);
a control device (42); and
a gearing (18) with a shift element (26) for changing a gear stage, a first gearing element (20), and a second gearing element (24), the gearing (18) configured to shiftably transmit a torque from the crank axle (12) to an output (22) with at least a first gear stage and a second gear stage, the first gearing element (20) connected to the second gearing element (24) by the shift element (26) for torque transmission in one of the first and second gear stages,
wherein the control device (42) is configured for detecting a request for a gear step change and for controlling the drive motor (38) depending on the request for the gear step change in order to reduce a load applied at the shift element (26).

21. The bicycle drive (10) of claim 20, wherein the shift element (26) comprises an interlocking shift element or a friction-locking shift element.

22. A bicycle comprising the bicycle drive (10) of claim 20.
